(19) United States
(12) Patent Application Publication
(10) Pub. No.: US 2004/0083655 A1
(43) Pub. Date: May 6, 2004

(54) Construction for arranging and supporting a cable of a slide door

(75) Inventors: Shigeru Suzuki, Yokkaichi-City (JP); Yoshinao Kobayashi, Yokkaichi-City (JP)

Correspondence Address: CASELLA & HESPOS, 274 MADISON AVENUE, NEW YORK, NY, 10016

(73) Assignee: Sumitomo Wiring Systems, Ltd., Yokkaichi-City (JP)

(21) Appl. No.: 10/695,196

(22) Filed: Oct. 27, 2003

(30) Foreign Application Priority Data
Oct. 28, 2002 (JP) 2002-312457

(51) Int. Cl. E05F 15/08

(52) U.S. Cl. 49/360; 49/352; 49/349; 49/348

(57) ABSTRACT

A slider (25) is mounted on a rail (23) laid on a slide door (21) to support a door-side end of a stretching part (31) of a cable transferred from a vehicle body (28) toward the slide door (21). The cable transferred toward the slide door (21) is introduced into a cable guide (27) and guided between the slider (25) and a fixing member (35). The cable guide (27) is formed by coupling a plurality of pieces (39) to undergo a bending deformation substantially in a plane, and takes up a slack of the cable while stabilizing the shape of the slackened cable.

### BACKGROUND OF THE INVENTION

1. Field of the Invention

The invention relates to a construction for arranging and supporting a cable of a slide door.

2. Description of the Related Art

Japanese Unexamined Patent Publication No. 2001-171443 and FIG. 19 herein show a construction for arranging and supporting a cable of a slide door. With reference to FIG. 19, a slide door 1 has a bottom part with a casing 3. The casing 3 is formed with a rail, and a slider 5 is installed on the rail. A fixing portion is provided at a portion of the slider 5 for fixing a cable 7. Further, a clamp 9 is provided on an upper inner wall surface of the casing 3 for fixing the cable 7.

The cable 7 is drawn from the vehicle body 11 into the casing 3 and is fixed to the slider 5. The cable 7 then is introduced into the clamp 9 and is fixed by the clamp 9. The cable 7 then is drawn out through the upper surface of the casing 3 and is connected with a specified connecting portion in the slide door 1. The cable 7 is stretched between the slider 5 and the clamp 9 and is slackened to a certain degree. The slackened degree and the shape of the slackened cable 7 change as the slider 5 makes a sliding movement. A distance between the slider 5 and a cable draw-out portion of the vehicle body 11 is substantially constant

The sliding movement of the slider 5 occurs as the slide door 1 is opened and closed. The slackened cable 7 between the slider 5 and the clamp 9 is accommodated in the casing 3 while the slider 5 is making a sliding movement. A part of the cable 7 between the slider 5 and the clamp 9 is introduced through a braided tube 13 formed by braiding resin threads into a tube for the cable protection. A part of the cable 7 more toward an end than the clamp 9 when viewed from the vehicle body 11 is introduced through a vinyl chloride tube 15 for the cable protection.

Japanese Patent Publication No. 3301021 discloses a slider mounted on a rail laid on a slide door. A cable transferred from a vehicle body toward the slide door is fixed partly to the slider and is connected with a specified connecting portion of the slide door via the slider. Further, a slack of the cable created between the slider and the connecting portion as the slider makes a sliding movement is taken up by a link arm or the like.

Japanese Unexamined Patent Publication No. 2000-264136, U.S. Pat. No. 6,174,020, Japanese Unexamined Patent Publication No. 2002-154389, Japanese Unexamined Patent Publication No. H11-348683, Japanese Unexamined Patent Publication No. 2000-92679, Japanese Unexamined Patent Publication No. H11-245738, Japanese Unexamined Patent Publication No. 2001-301545, Japanese Unexamined Patent Publication No. H11-342807, Japanese Unexamined Patent Publication No. 2000-234470, Japanese Unexamined Patent Publication No. 2002-2288, Japanese Unexamined Utility Model Publication No. H5-28893, Japanese Unexamined Patent Publication No. H7-222274 and Registered Utility Model No. 2543239 disclose other known prior art relating to the invention.

The slack of the cable 7 created as the slider 5 makes the sliding movement is taken up and held in the casing 3 according to the first prior art. Thus, the casing 3 is necessary and the construction is heavier and costlier by providing the casing 3.

Further, a space for the link arm or the like must be defined in the second prior art since the slack of the cable is taken up by the link arm in the second prior art. Therefore, it is difficult to provide the link arm if there is a large sliding distance of the slider.

Accordingly, an object of the invention is to provide a construction for arranging and supporting a cable of a slide door, which construction can be lighter and produced at lower costs and can be applied even if a sliding distance of a slider is large.

### SUMMARY OF THE INVENTION

The invention relates to a construction for arranging and supporting a cable of a slide door. The construction comprises a slider to be mounted on a rail laid on the slide door in a manner to be slidable along the rail and adapted to support a door-side end of a stretching part of the cable transferred from a vehicle body toward the slide door. A cable guide is formed to undergo a bending deformation only substantially in a specified plane. One end of the cable guide is coupled to the slider and the other end is coupled to a fixing portion to be fixed to the slide door. The cable guide is adapted to guide the cable introduced therein in a section between the slider and the fixing portion.

The cable guide restricts the shape of the slackened cable between the slider and the fixing portion to the specified plane as the slider makes a sliding movement. The shape of the slackened cable in this section can be taken up and stabilized without the prior art casing or link arm. As a result, the cable arranging and supporting construction is lighter and is produced at lower costs and can be applied even if a sliding distance of the slider is large.

The cable guide may comprise substantially tubular links substantially linearly coupled to undergo a bending deformation substantially in the specified plane.

Alternatively, the cable guide may comprise a corrugate tube constructed so that a bending direction is restricted to a specified direction and so that a bending deformation lies substantially in a specified plane. The tube may have a plurality of annular small-diameter portions and a plurality of annular large-diameter portions provided alternately and substantially continuously. Substantially flat couplings preferably are provided at opposite sides of the tube and couple the adjacent annular large-diameter portions. The couplings and the large-diameter annular portions preferably are substantially flush with each other and define parts of a cylindrical locus extending along the tube. Thus, the large-diameter annular portions and the couplings along one side of the corrugate tube would be tangent to a line along that side of the tube.

The flat couplings that couple adjacent annular large-diameter portions are at least along longitudinal side of the tube. Thus, the side of the tube with the flat couplings is difficult to deform in a way that will widen or reduce the distance of the adjacent annular large diameter portions. Conversely, the side with no couplings is relatively easy to elongate. Accordingly, the cable guide is difficult to bend in a direction that will dispose the flat couplings at the inner or outer circumferential side of the bend because that side of the tube is relatively difficult to deform. Thus, the bent state of the cable guide can be restricted so that the cable guide is bent substantially in the specified plane.

The rail preferably is on a surface facing the vehicle body and has a rail-side engaging portion with which a slider-side engaging portion of the slider is slidably engaged. Thus, a bulging distance of the rail from the door panel toward the vehicle body can be made smaller.

The slider preferably is mounted on the rail to bulge out toward the vehicle body from the rail. The cable guide is coupled to the slider so that a slider-side opening thereof is faced substantially down or sideways. Additionally, the door-side end of the stretching part is supported by the slider near the slider-side opening of the cable guide.

At least part of the rail preferably is substantially linear. Accordingly, the rail can be formed easily by cutting a long linear piece of raw rail material.

A moving path of the slide door may be curved vertically and/or transversely. In this situation, at least one section of the rail may be curved. Thus, the space defined between the slider and the fixing portion on the vehicle body can be held substantially constant as the slide door is opened and closed by adjusting the curved shape of the rail in accordance with the curved shape of this sliding path. In this way, the opening and closing of the slide door can be dealt with while the length of the stretching part of the cable is kept short.

The angle of the slide door to the vertical direction may change in the process of sliding the slide door. In this situation, the bulging direction of the slider from the rail can be held in a specified direction in the process of opening and closing the slide door by adjusting the twisted shape of the rail in accordance with the angular change. This can prevent a bending load from being exerted on the stretching part of the cable by the opening and closing of the slide door.

The rail and the slider are provided respectively with a rail-side engaging portion and a slider-side engaging portion which are engageable with each other. The slider-side engaging portion may have engaging grooves in the upper and lower surfaces thereof, and the rail-side engaging portion may have engaging projections fit in the engaging grooves of the slider-side engaging portion from above and below and extending along the longitudinal direction of the rail.

Alternatively, the rail-side engaging portion may have one or more engaging grooves in the upper and lower surfaces thereof along the longitudinal direction of the rail, and the slider-side engaging portion may have one or more engaging projections fittable into the respective engaging grooves of the rail-side engaging portion from above and from below.

As a further alternate, the rail-side engaging portion may have at least one fit-in portion extending along the longitudinal direction of the rail, and the slider-side engaging portion have at least one holding groove into which the fit-in portion is fit and held so as not to come off.

Still further, the slider-side engaging portion may have at least one fit-in portion, and the rail-side engaging portion have at least one holding groove into which the fit-in portion is fit and held so as not to come off and which extends along the longitudinal direction of the rail.

A roller may be provided at a portion of the slider-side engaging portion held in sliding contact with the rail-side engaging portion to ensure smooth sliding.

These and other objects, features and advantages of the present invention will become more apparent upon reading of the following detailed description of preferred embodiments and accompanying drawings. It should be understood that even though embodiments are separately described, single features thereof may be combined to additional embodiments.

### BRIEF DESCRIPTION OF THE DRAWINGS

FIG. 1 is a front view of a construction for arranging and supporting a cable of a slide door according to one embodiment of the invention.

FIG. 2 is a perspective view partially showing the cable arranging and supporting construction of FIG. 1.

FIG. 3 is a side view of a piece member forming a cable guide.

FIG. 4 is a front view of the piece member of FIG. 3.

FIG. 5 is a section along 5-5 of FIGS. 3 and 4.

FIG. 6 is a section of an engaging construction of a rail and a slider.

FIG. 7 is a section of a modified engaging construction of FIG. 6.

FIG. 8 is a section showing another modification of the engaging construction of FIG. 6.

FIG. 9 is a section showing still another modification of the engaging construction of FIG. 6.

FIG. 10 is a section showing further another modification of the engaging construction of FIG. 6.

FIGS. 11(a) to 11(d) are diagrams showing states when the slide door is opened and closed.

FIG. 12 is a diagram showing a modification of the rail.

FIGS. 13(a) to 13(h) are diagrams showing states when the slide door is opened and closed in a vehicle construction adopting the rail of FIG. 12.

FIG. 14 is a perspective of a modification of the cable guide of FIG. 1.

FIG. 15 is a plan view of the cable guide of FIG. 14.

FIG. 16 is a section along 16-16 of FIG. 15.

FIG. 17 is a diagram used for the explanation of a restriction on the bending of the cable guide of FIG. 14

FIG. 18 shows a bending-restricted state of the cable guide of FIG. 14.

FIG. 19 is a diagram showing a construction for arranging and supporting a cable of a slide door according to a first prior art.

### DETAILED DESCRIPTION OF THE PREFERRED EMBODIMENTS

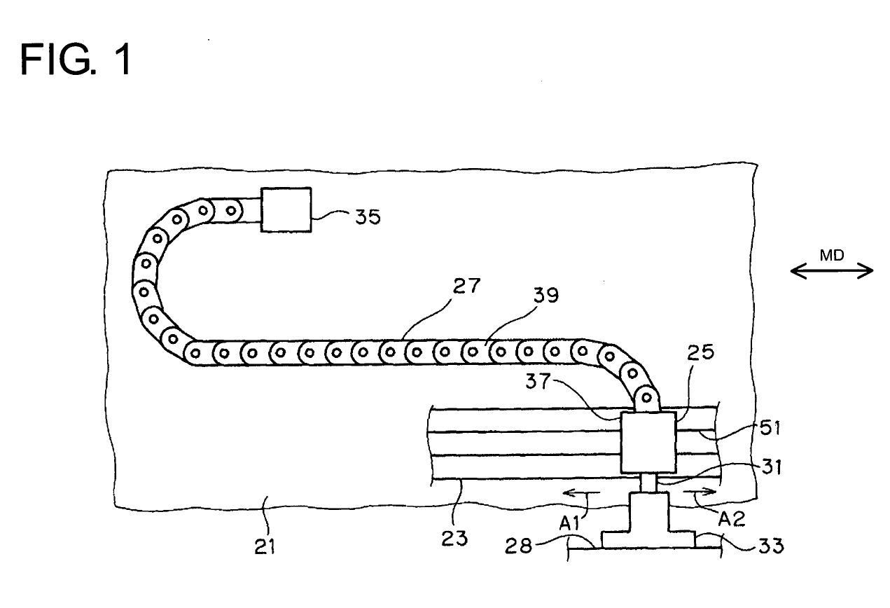

A cable arranging and supporting construction according to the invention is adapted to provide power and/or signals to a slide door 21. The construction includes a rail 23 mounted to the slide door 21, as shown in FIG. 1. The construction also includes a slider 25 and a cable guide 27, which generally looks like a part of a caterpillar tread.

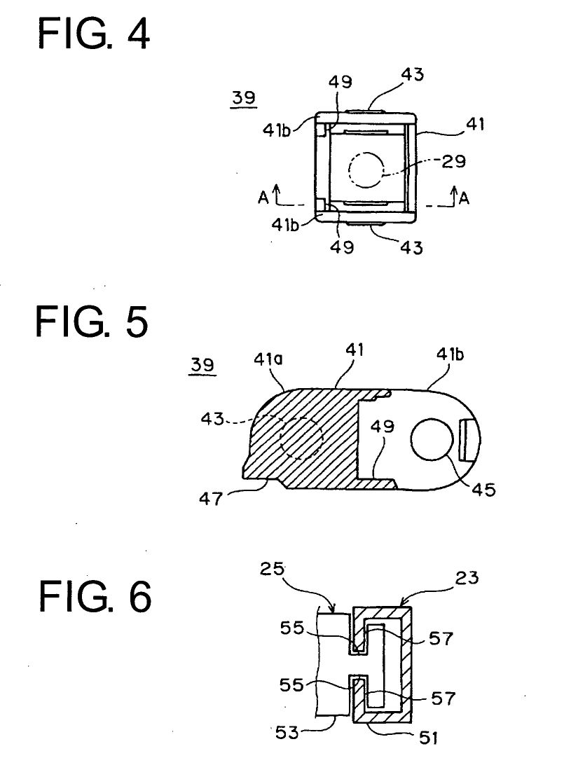

The rail 23 extends substantially straight along moving directions MD of the slide door 21. The slider 25 is mounted on the rail 23 to slide in directions of arrows A1, A2 substantially along the rail 23. The slider 25 supports a door-side end in a spanning part 31 of a cable 29 (see FIG. 4) transferred from a body 28 toward the slide door 21 for bridging the body 28 and the slide door 21 with a variable length or over a variable distance.

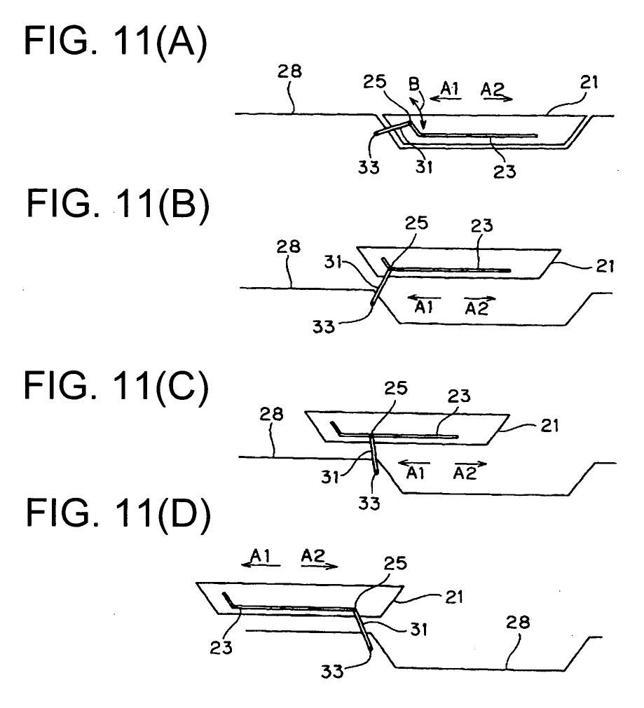

The cable 29 is introduced through the cable guide 27 and transferred from a fixing member 33 on the vehicle body 28 to the slider 25 on the slide door 21. The cable 29 then is connected with a connecting portion via a fixing member 35 that is fixed to the slide door 21 by a fixing device, such as a clip. The stretching part 31 of the cable 29 is introduced through a corrugate tube or a cable guide (e.g. which looks like a part of a caterpillar tread similar to the cable guide 27). Opposite ends of the stretching part 31 are supported on the fixing member 33 and a cable-support 37 of the slider 25. The fixing member 33 supports a body-side end of the stretching part 31 such that the stretching part 31 is pivotal in directions of arrows B in FIG. 11(a).

The cable guide 27 is formed by pieces 39 shown in FIGS. 3 to 5. The pieces 39 are coupled to pivot with respect to each other substantially in a plane. Each piece 39 is made e.g. of resin and includes a trunk 41. Two projections 43 are provided at one end of the trunk 41 and function as a pivotal shaft. Two receiving portions 45 are formed at the other end of the trunk 41 and are adapted to pivotably support the projections 43 of a mating piece 39. Two first contacts 47 are provided at the one side of the trunk 41, and two second contacts 49 are provided at the other side of the trunk 41.

The trunk 41 is a substantially rectangular tube and has inner dimensions for receiving the cable 29. The projections 43 bulge out on substantially opposed extensions 41a so that an opening at one end of the trunk 41 is between the projections 43. The receiving portions 45 are formed in substantially opposed extensions 41b so that an opening at the other end of the trunk 41 is between the receiving portions 45. The projections 43 and the receiving portions 45 are provided such that an axis connecting the projections 43 is substantially parallel to an axis connecting the receiving portions 45.

A space between the extensions 41b where the receiving portions 45 are formed is slightly wider than an outside dimension on the extensions 41a where the projections 43 are provided. Thus, the projections 43 of one piece 39 can be at engaged with the receiving portions 45 of another piece 39 from the inner side to couple the two pieces 39 pivotally. The projections 43 are held pivotably in the receiving portions 45 in this coupled state so that a relative angle is variable at the coupled pieces 39.

The first and second contacts 47, 49 of two coupled pieces 39 are can contact each other for restricting the bending direction and the bending angle of the coupled pieces 39. The bending direction and a maximum bending angle of the coupled pieces 39 is determined the shapes of the contacts 47, 49.

A plurality of kinds of pieces 39 are provided with differently shaped contacts 47, 49. Thus, desired kinds of pieces 39 are selected and coupled so that the bent state of the cable guide 27 can be restricted. For example, the bent state of the cable guide 27 can be slackened when the slider 25 is near the fixing member 35.

As shown in FIG. 1, the cable guide 27 has one end coupled to the cable support 37 of the slider 25 and the other end coupled to the fixing member 35. Thus, the cable guide 27 guides the cable 29 that has been inserted therein between the slider 25 and the fixing member 35.

The cable guide 27 changes its bent state substantially in a specified plane substantially along a vertical direction while the slider 25 makes a sliding movement as the slide door 21 is opened and closed. The plane is substantially perpendicular to the direction of movement of the slide door 21 and/or of the slider 25. Thus, a slackened state of the cable 29 between the slider 25 and the fixing member 51 is restricted to stabilize the slackened shape of the cable 29 and take up a slack of the cable 29.

The cable support 37 of the slider 25 is a tube with open upper and lower ends. The door-side end of the stretching part 31 of the cable 29 is pulled in through a bottom opening of the cable support 37 and is fixed to the cable support 37. One end of the cable guide 27 is pulled in through an upper opening of the cable support 37 and is fixed to the cable support 37 with an opening at this end faced down. The door-side end of the stretching part 31 of the cable 29 is fixed to the cable support 37 near an opening at the bottom end of the cable guide 27 to face this opening. The cable 29 is pulled into the cable support 37 from the below and is introduced to the upper side of the cable support 37 to be inserted into the cable guide 27. The one end of the cable guide 27 may be fixed to the cable support 37 with the opening at the one end faced sideways.

As shown in FIG. 6, the rail 23 and the slider 25 are provided with a rail-side engaging portion 51 and a slider-side engaging portion 53 that engage with each other to slidably hold the slider 25. The rail 23 is laid so that the rail-side engaging portion 51 faces the vehicle body. In other words, the rail-side engaging portion 51 is on a surface of the rail 23 that faces the vehicle body. The slider 25 is so mounted on the rail 23 to bulge out toward the vehicle body.

Engaging grooves 55 are formed in upper and/or lower surfaces of the slider-side engaging portion 53. The rail-side engaging portion 51 has engaging projections 57 that fit into the respective engaging grooves 55 of the slider-side engaging portion 51 from above and/or from below and that extend substantially along the longitudinal direction of the rail 23.

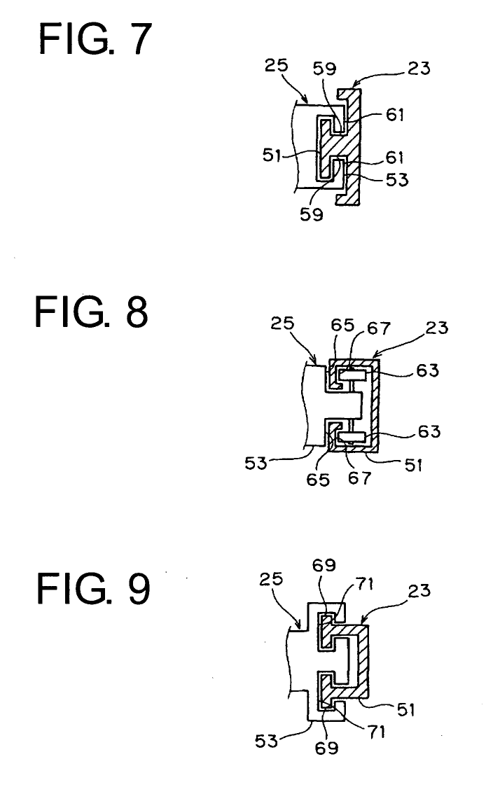

Modifications of the rail 23 and the slider 25 are shown in FIGS. 7 to 10. In the modification of FIG. 7, the rail-side engaging portion 51 has engaging grooves 59 formed in the upper and lower surfaces that extend along the longitudinal direction of the rail 23. The slider-side engaging portion 53 has engaging projections 61 that fit into the respective engaging grooves 59 of the rail-side engaging portion 51 from above and below.

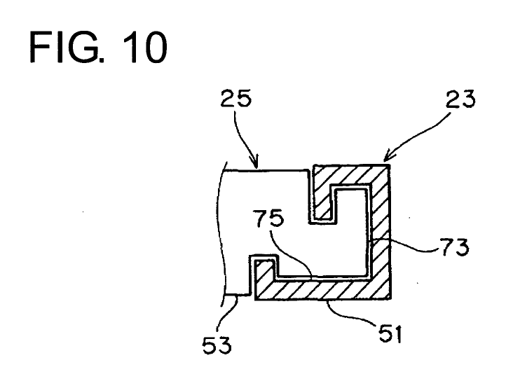

In the modification of FIG. 8, rollers 63 are provided at portions of the slider-side engaging portion 53 held in sliding contact with the rail-side engaging portion 51. More specifically, the rollers 63 are rotatable about substantially vertical shafts at upper and lower sides of the leading end of the slider-side engaging portion 53. Engaging grooves 65 are defined between the rollers 63 and a substantially vertical wall of the slider-side engaging portion 53 that faces the rollers 63. The rail-side engaging portion 51 has engaging projections 67 fit into the upper and lower grooves 65. According to this modification, the rollers 63 permit the slider 25 to slide. The rollers 63 may be at portions of the slider-side engaging portion 53 held in sliding contact with the rail-side engaging portion 51 in the constructions shown in FIGS. 6 and 7 and those shown in FIGS. 9 and 10.

In the modification of FIG. 9, the rail-side engaging portion 51 has two substantially vertically extending fit-in portions 69 spaced vertically apart and extending substantially along the longitudinal direction of the rail 23. The slider-side engaging portion 53 has two holding grooves 75 into which the fit-in portions 69 are fit and held so as not to come off.

In the modification of FIG. 10, the rail-side engaging portion 51 has a holding groove 71 that extends along the longitudinal direction of the rail 23. The slider-side engaging portion 53 has a substantially vertically extending fit-in portion 73 that is fit in and held on the holding groove 71.

FIGS. 11(a) to 11(d) are diagrams showing opening/closing states of the slide door 21 at the left side of the vehicle body when viewed from above. The rail 23 is curved to conform to a moving path during the opening and closing of the slide door 21. In this example, the rail 23 has opposite longitudinal bent at obtuse. Even in such cases, the basic movements of the slider 25 are the same as in the case of the substantially linear rail 23 of FIG. 1.

The slider 25 is at an end of the rail 23 with respect to the arrow A1 when the slide door 21 is closed as shown in FIG. 11(a). However, the slider 25 slides on the rail 23 in the direction of arrow A2 as the slide door 21 is opened in the direction of arrow A1, as shown in FIGS. 11(b) and 11(c). The slider 25 is at an end of the rail 23 with respect to the direction of arrow A2 in a fully opened state of the slide door 21 shown in FIG. 11(d). A reverse order of movement is followed when the slide door 21 is closed.

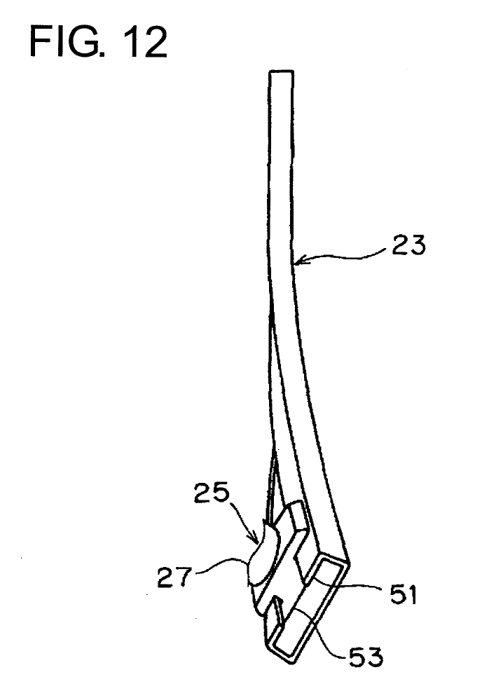

The rail 23 can be twisted about a longitudinal axis and curved with respect to the longitudinal direction, as shown in FIG. 12.

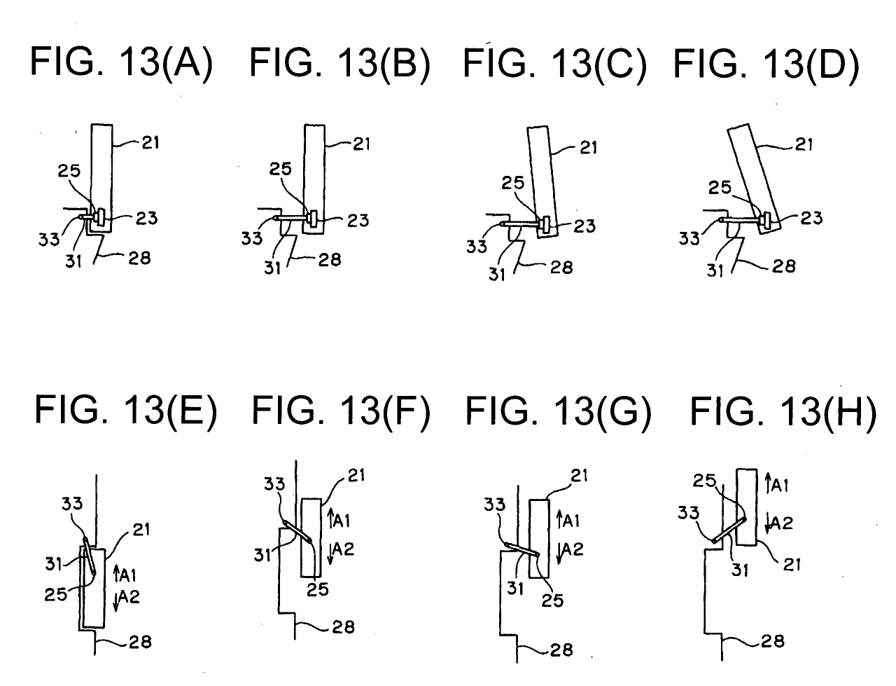

FIGS. 13(a) to 13(d) show the opening/closing states of the slide door 21 at the left side of the vehicle body when viewed from the front, and FIGS. 13(e) to 13(h) showing the opening/closing states of the slide door 21 when viewed from above. The angle of the slide door 21 to the vertical direction changes as the slide door 21 is opened from the closed state shown in FIGS. 13(a) and 13(e) to the opened state shown in FIGS. 13(b), 13(f), 13(c) and 13(g). Specifically, an angle of inclination of the slide door 21 to vertical direction increases so that the bottom of the slide door 21 moves farther away from the vehicle body 28 as the slide door 21 is moved in the opening direction of arrow A1. FIGS. 13(d) and 13(h) show the fully opened state of the slide door 21. The rail 23 shown in FIG. 12 can accommodate the angular change of the slide door 21 as shown in FIGS. 13(a) to 13(h).

As described above, the cable 29 is introduced into the cable guide 27 formed by coupling a plurality of pieces 39 so as to undergo a bending deformation substantially in a plane and guided in the section between the slider 25 and the fixing member 35. Thus, the shape of the slackened cable 29 between the slider 25 and the fixing member 35 as the slider 25 makes a sliding movement is restricted to the specified plane, and the shape of the slackened cable 29 in the section between the slider 25 and the fixing member 35 can be taken up and stabilized without the casing or link arm of the prior art. As a result, the cable arranging and supporting construction is lighter and less costly and can accommodate a large sliding distance of the slider 25.

The prior art casing and link arm are not used. Thus, a design change can be accommodated merely by adjusting the length of the rail 23 and the length of the cable guide 27 without necessarily forming new molds.

The rail-side engaging portion 51 is on the surface of the rail 23 facing the vehicle body. Thus, a bulging distance of the rail 23 from a door panel toward the vehicle body is smaller.

The linear rail 23 shown in FIG. 1 and other figures can be formed easily merely by cutting a long linear raw rail material to a specified length.

The curved rail 23 shown in FIG. 11(a) and other figures, accommodates a moving path of the slide door 21 that is curved vertically and/or transversely. However, the spacing between the slider 25 and the cable fixing portion of the vehicle body 28 defined as the slide door 21 is opened and closed can be held substantially constant by adjusting the curved shape of the rail 23 in accordance with the curved shape of the moving path. In this way, the opening and closing of the slide door 21 can be dealt with while the length of the stretching part 31 of the cable 29 is suppressed to a short length.

The angle of the slide door 21 to vertical direction may change in the process of sliding the slide door 21. However, the bulging direction of the slider 25 from the twisted rail 23 of FIG. 12 can be held in a specified direction in the process of opening and closing the slide door 21 by adjusting the twisted shape of the rail 23 in accordance with the angular change. This can prevent a bending load from being exerted on the stretching part 31 of the cable 29 by the opening and closing of the slide door 21.

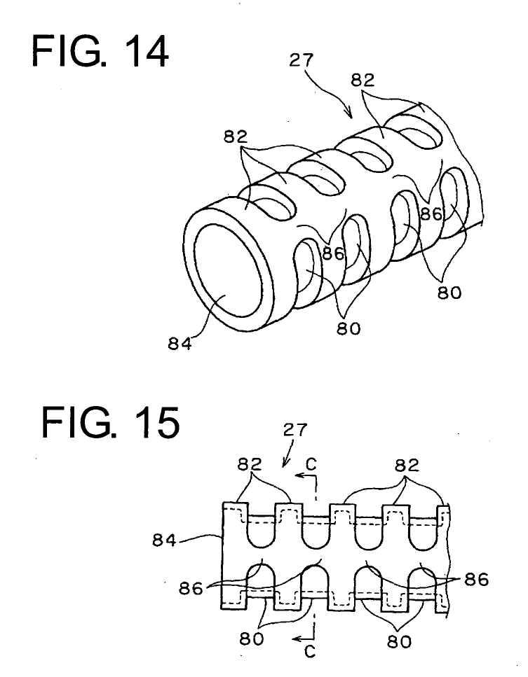

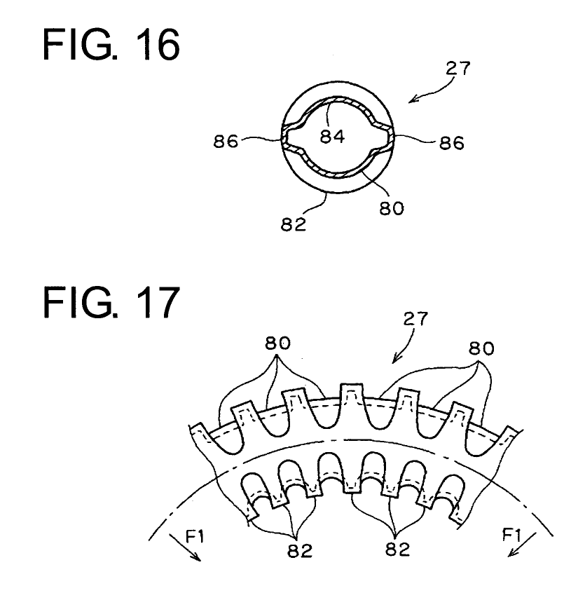

A modification of the cable guide 27 is made e.g. of a resin and has substantially the shape of a corrugate tube 84, as shown in FIGS. 14 to 16. The tube 84 has a plurality of annular small-diameter portions or arc sections 80 and a plurality of annular large-diameter portions or rings 82 alternately and substantially continuously provided without leaving any space between them.

The outer diameter of the annular small-diameter portions 80 is smaller than that of the annular large-diameter portions 82. Accordingly, the outer circumferential surface of the tube 84 is alternately recessed and projected along the longitudinal direction thereof. The annular small-diameter portions 80 and the annular large-diameter portions 82 have substantially the same thickness. Accordingly, the inner circumferential surface of the tube 84 also is recessed and projected along the longitudinal direction.

At least at one side of the tube 84 has flat couplings 86 that couple adjacent annular large-diameter portions 82 along the longitudinal direction of the tubular element 84. The couplings 86 are substantially flush with the annular large-diameter portions 82. The couplings 86 are formed in two longitudinal rows along diametrically opposite sides of the tube 84. Accordingly, the annular small portions 80 are defined in a specified circumferential range by the adjacent annular large diameter portions 82 and the couplings 86 to define an elongated O-shape window like configuration.

The couplings 86 have substantially the same thickness as the annular large-diameter portions 82. Thus, sides of the tube 84 where the couplings 86 are formed, have substantially flat inner and outer circumferential surfaces that are free from recesses and projections.

The annular small-diameter portions 80, the annular large-diameter portions 82 and the flat couplings 86 need not always have the same thickness. For example, the annular large-diameter portions 82 may be thicker than the annular small-diameter portions 80 and the flat couplings 86 may be substantially as thick as the annular large-diameter portions 82.

The flat couplings 86 need not be flush with the annular large-diameter portions 82 both on the outer and inner circumferential surfaces of the tube 84. However, the flat couplings 86 that are substantially flush with the annular large-diameter portions 82 are relatively difficult to elongate on either the outer or inner circumferential side of the tube 84.

The sides of the tube 84 that have the flat couplings 86 are free from projections and recesses and are relatively difficult to elongate along the longitudinal direction of the tube 84. On the other hand, the sides of the tube 84 that have no flat coupling 86 can be deformed relatively easily along the longitudinal direction of the tube 84. More particularly, the annular small-diameter portions 80 and the annular large-diameter portions 82 are alternately and continuously coupled to each other to form projections and recesses. Thus, the annular large diameter portions 82 are more likely to move away or towards each other. Such movement enlarges or reduces the longitudinal distance between adjacent annular large diameter portions 82 in a circumferential position of the cable guide 27 where the flat couplings 86 are not provided as compared to the circumferential position where the flat couplings 86 are provided. Accordingly, the flat couplings 86 act as a pivot joint, similar to the projections 43 and the receiving portions 45 of the first embodiment.

Accordingly, the cable guide 27 can undergo a bending deformation with relative ease if a force F1 is exerted to bend the cable guide 27 in a direction so that a first area that has no flat couplings 86 defines the outer side of the bend and so that a second area that has no flat couplings 86 defines the inner side, as shown in FIG. 17.

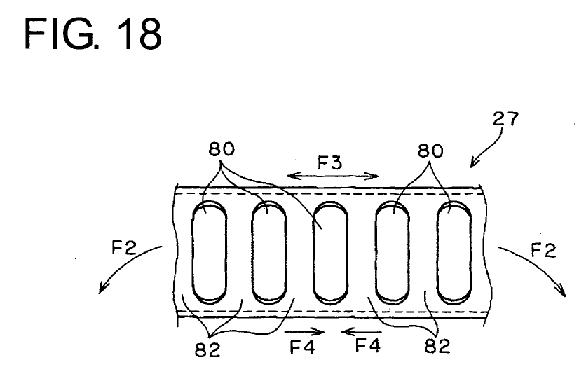

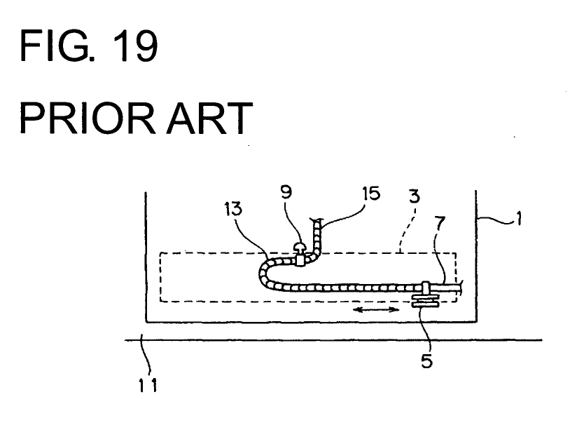

On the other hand, a force F2 could be exerted to bend the cable guide 27 so that one line of the flat couplings 86 is at the outer side of the bend and the other line of the flat couplings 86 are at the inner side, as shown in FIG. 18. In this situation, a force F3 acts to elongate the one line of the flat couplings 86 are formed, and a force F4 acts to compress the other line of the flat couplings 86. However, these sides are difficult to elongate or compress. Thus, the bending deformation of the cable guide 27 in this direction is suppressed.

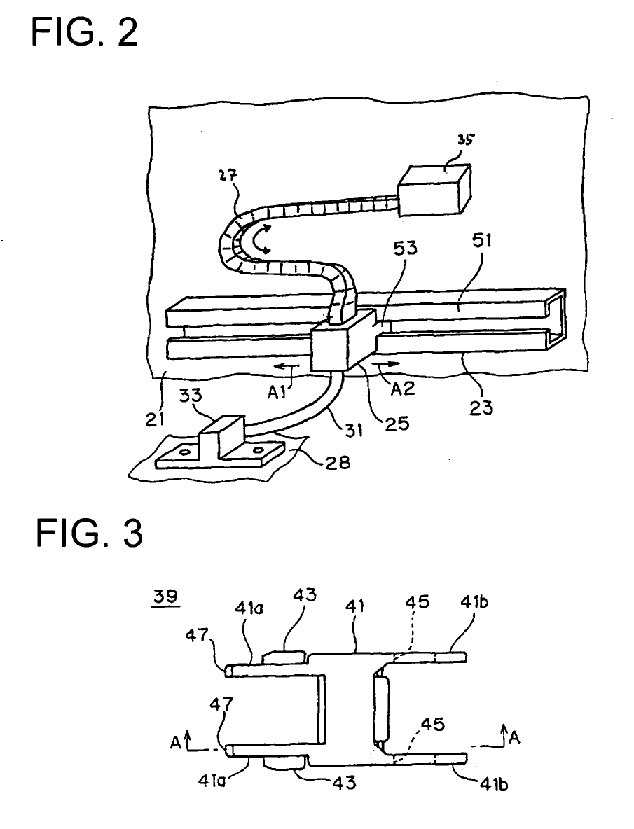

Accordingly, bending of the cable guide 27 is restricted to substantially a specified plane that includes the lines of the flat couplings 86. Therefore, the cable guide 27 of FIGS. 14 to 18 achieves substantially the same effects as the first embodiment illustrated in FIGS. 1 to 6.

The cable guide 27 of FIGS. 14 to 18 can be used as to hold the cable guide 27 between an outer plate of the slide door 21 and an inner panel to restrict the bent state of the cable guide 27.

The prior art casing and the link arm are not used. Thus, a design change can be accommodated merely by adjusting the length of the rail and the length of the cable guide without forming new molds.

Moreover, the cable is introduced into the corrugate tube-shaped cable guide between the slider and the fixing portion fixed to the slide door. The cable guide can be bent in only specified directions. Thus, the cable guide restricts the shape of the slackened cable between the slider and the fixing portion to a specified plane as the slider makes a sliding movement. The shape of the slackened cable in this section can be taken up and stabilized without the prior art casing or link arm. As a result, the cable arranging and supporting construction is lighter and less costly and can be applied even if a sliding distance is large.

The flat couplings that couple the adjacent annular large-diameter portions are provided at least at one circumferential side of the tube and extend substantially along the longitudinal direction of the tube. The side of the tube with the flat couplings is difficult to elongate, whereas the side with no coupling is relatively easy to elongate. Thus, the cable guide cannot be bent easily in a direction that will elongate the flat couplings. Accordingly, the flat couplings can be oriented so that a bent state of the cable guide is restricted to a specified plane.

The rail-side engaging portion of the rail is on the surface of the rail that faces the vehicle body. Thus, a bulging distance of the rail from the door panel toward the vehicle body can is smaller.

The rail preferably is linear and can be formed easily by cutting a long linear raw rail material to a specified length.

A moving path of the slide door may be curved vertically and/or transversely. However, the space between the slider and the fixing portion on the vehicle body as the slide door is opened and closed can be held substantially constant by adjusting the curved shape of the rail in accordance with the curved shape of the sliding path. Thus, the opening and closing of the slide door can be dealt with while the stretching part of the cable can be short.

The angle of the slide door to the vertical direction may change in the process of sliding the slide door. However, the bulging direction of the slider from the rail is held in a specified direction in the process of opening and closing the slide door by adjusting the twisted shape of the rail in accordance with the angular change. This prevents a bending load from being exerted on the stretching part of the cable by the opening and closing of the slide door.

What is claimed is:

1. A construction for arranging and supporting a cable (29) of a slide door (21), comprising:
a slider (25) to be mounted on a rail (23) laid on the slide door (21) for sliding along the rail (23) and adapted to support a door-side end of a stretching part (31) of the cable (29) transferred from a vehicle body (28) toward the slide door (21); and
a cable guide (27) formed to undergo a bending deformation only substantially in a specified plane, the cable guide (27) having a first end coupled to the slider (25) and a second end coupled to a fixing portion (35) for fixed coupling to the slide door (21), and adapted to guide the cable (29) introduced therein in a section between the slider (25) and the fixing portion (35).

2. The construction of claim 1, wherein the cable guide (27) comprises a plurality of substantially tubular links (39) coupled to undergo a bending deformation substantially in the specified plane.

3. The construction of claim 1, wherein the cable guide (27) comprises a corrugate tube (84) configured such that a bending direction is restricted to a specified direction to undergo a bending deformation substantially in the specified plane.

4. The construction of claim 3, wherein the corrugate tube (84) has a plurality of annular small-diameter portions (80) and a plurality of annular large-diameter portions (82) alternately and substantially continuously provided, and substantially flat couplings (86) for coupling adjacent annular large-diameter portions (82) substantially flush with each other.

5. The construction of claim 1, wherein a rail-side engaging portion (51) is provided on a surface of the rail (23) facing the vehicle body (28), the rail-side engaging portion (51) being slidably engageable with a slider-side engaging portion (53) of the slider (25).

6. The construction of claim 1, wherein the slider (25) is mounted on the rail (23) to bulge toward the vehicle body (28), the cable guide (27) is coupled to the slider (25) such that a slider-side opening thereof faces transversely; and the door-side end of the stretching part (31) is supported by the slider (25) near the slider-side opening of the cable guide (27).

7. The construction of claim 1, wherein the rail (23) is substantially linear.

8. The construction of claim 1, wherein the rail (23) has a section curved with respect to a longitudinal direction of the rail (23).

9. The construction of claim 1, wherein the rail (23) is twisted about a longitudinal axis at least in one section thereof with respect to a longitudinal direction of the rail (23).

10. The construction of claim 1, wherein: the rail (23) and the slider (25) are provided respectively with a rail-side engaging portion (51) and a slider-side engaging portion (53) engageable with each other to slidably hold the slider (25).

11. The construction of claim 10, wherein the slider-side engaging portion (53) has engaging grooves (55) in upper and lower surfaces thereof, and the rail-side engaging portion (51) has engaging projections (57) fit in the engaging grooves (55) of the slider-side engaging portion (53) from above and from below and extending along a longitudinal direction of the rail (23).

12. The construction of claim 10, wherein the rail-side engaging portion (51) has engaging grooves (59) in the upper and lower surfaces thereof along a longitudinal direction of the rail (23), and the slider-side engaging portion (53) has engaging projections (61) fit in the respective engaging grooves (59) of the rail-side engaging portion (51) from above and from below.

13. The construction of claim 10, wherein the rail-side engaging portion (51) has a fit-in portion (69) extending substantially along the longitudinal direction of the rail (23), and the slider-side engaging portion (53) has a holding groove (71) into which the fit-in portion (69) is fit and held so as not to come off.

14. The construction of claim 10, wherein the slider-side engaging portion (53) has a fit-in portion (73), and the rail-side engaging portion (51) has a holding groove (75) into which the fit-in portion (73) is fit and held so as not to come off and which extends substantially along a longitudinal direction of the rail (23).

15. The construction of claim 14, wherein at least one roller (63) is provided at a portion of the slider-side engaging portion (53) held substantially in sliding contact with the rail-side engaging portion (51).

16. A construction for arranging and supporting a cable (29) of a slide door (21), comprising:
a slider (25) to be mounted on a rail (23) laid on the slide door (21) for sliding along the rail (23) and adapted to support a door-side end of a stretching part (31) of the cable (29) transferred from a vehicle body (28) toward the slide door (21); and
a corrugate tube (84) having a first end coupled to the slider (25) and a second end coupled to a fixing portion (35) for fixed coupling to the slide door (21), and adapted to guide the cable (29) introduced therein in a section between the slider (25) and the fixing portion (35), the corrugate tube (84) having a plurality of longitudinally spaced rings (82), each said ring (82) defining a selected large diameter, a diametrically opposed pair of arc sections (80) extending between longitudinally adjacent rings (82) and defining a selected small diameter less than the large diameter, and diametrically opposed pairs couplings (86) defining the large diameter, each said diametrically opposed pair of couplings (86) coupling longitudinally adjacent rings (82) and coupling the diametrically opposed arc sections (80) in each said pair, such that the corrugate tube (84) can undergo a bending deformation only in a plane substantially centrally between the couplings (86).

17. The construction of claim 16, wherein the corrugate tube (84) is formed unitarily from resin.

18. The construction of claim 17, wherein the couplings (86) in each said pair are aligned longitudinally with the couplings (86) in the other pairs.
